(19) United States
(12) Patent Application Publication
(10) Pub. No.: US 2004/0248731 A1
(43) Pub. Date: Dec. 9, 2004

(54) Furnace carbon black, process for production and use thereof

(75) Inventors: Karl Vogel, Alzenau (DE); Emmanuel Auer, Frankfurt (DE); Karl-Anton Starz, Rodenbach (DE); Peter Albers, Hanau (DE); Klaus Bergemann, Erlensee (DE); Conny Vogler, Bernheim (DE)

Correspondence Address: PILLSBURY WINTHROP, LLP, P.O. BOX 10500, MCLEAN, VA, 22102, US

(73) Assignee: Degussa-Huls AG, Frankfurt am Main (DE)

(21) Appl. No.: 10/793,734

(22) Filed: Mar. 8, 2004

Related U.S. Application Data
(63) Continuation of application No. 09/645,554, filed on Aug. 25, 2000, now abandoned.

(30) Foreign Application Priority Data
Aug. 27, 1999 (EP) 99116930.1

(51) Int. Cl. C09C 1/48

(52) U.S. Cl. 502/185

(57) ABSTRACT

Furnace carbon black which has a hydrogen (H) content of greater than 4000 ppm and a peak integral ratio of non-conjugated H atoms (1250-2000 cm⁻¹) to aromatic and graphitic H atoms (1000-1250 cm⁻¹ and 750-1000 cm⁻¹) of less than 1.22. The furnace carbon black is produced by injecting the liquid carbon black raw material and the gaseous carbon black raw material at the same point in a furnace carbon black process. The furnace carbon black may be used in the preparation of electrocatalysts.

### CROSS-REFERENCE TO RELATED APPLICATION

This application is based on European Application 99116930.1, filed Aug. 27, 1999, which disclosure is incorporated herein by reference.

### FIELD OF THE INVENTION

The invention relates to a furnace carbon black, to a process for its production and to its use.

### BACKGROUND OF THE INVENTION

Furnace carbon blacks can be produced in a furnace carbon black reactor by the pyrolysis of hydrocarbons, as is known from Ullmanns Encyklopädie der technischen Chemie, Volume 14, page 637-640 (1977). In the furnace carbon black reactor, a zone having a high energy density is produced by burning a fuel gas or a liquid fuel with air, and the carbon black raw material is injected into that zone. The carbon black raw material is pyrolyzed at temperatures from 1200° C. to 1900° C. The structure of the carbon black may be influenced by the presence of alkali metal or alkaline earth metal ions during the carbon black formation, and such additives are therefore frequently added in the form of aqueous solutions to the carbon black raw material. The reaction is terminated by the injection of water (quenching) and the carbon black is separated from the waste gas by means of separators or filters. Because of its low bulk density, the resulting carbon black is then granulated. Granulation may be carried out in a pelletizing machine with the addition of water to which small amounts of a pelletizing auxiliary may be added.

In the case of the simultaneous use of carbon black oil and gaseous hydrocarbons, such as, for example, methane, as the carbon black raw material, the gaseous hydrocarbons may be injected into the stream of hot waste gas separately from the carbon black oil through their own set of gas lances.

If the carbon black oil is divided between two different injection points which are offset relative to each other along the axis of the reactor, then at the first, upstream point, the amount of residual oxygen still contained in the combustion chamber waste gas is present in excess relative to the carbon black oil that is sprayed in. Accordingly, carbon black formation takes place at a higher temperature at that point as compared with subsequent carbon black injection sites, that is to say the carbon blacks formed at the first injection point are always more finely divided and have a higher specific surface area than those formed at a subsequent injection point. Each further injection of carbon black oils leads to further temperature reductions and to carbon blacks having larger primary particles. Carbon blacks produced in this manner therefore exhibit a broadening of the aggregate size distribution curve and, after incorporation into rubber, show different behavior than carbon blacks having a very narrow monomodal aggregate size spectrum. The broader aggregate size distribution curve leads to a lower loss factor of the rubber mixture, that is to say to a lower hysteresis, which is why one also speaks of low hysteresis carbon blacks. Carbon blacks of this type, and processes for their production, are described in patent specifications EP 0 315 442 and EP 0 519 988.

DE 19521565 discloses furnace carbon blacks having CTAB values from 80 to 180 m²/g and 24M4-DBP absorption from 80 to 140 ml/100 g, for which, in the case of incorporation into an SSBR/BR rubber mixture, a tanδ₀/tanδ₆₀ ratio of

tanδ₀/tanδ₆₀>2.76−6.7×10⁻³×CTAB

applies and the tanδ₆₀ value is always lower than the value for ASTM carbon blacks having the same CTAB surface area and 24M4-DBP absorption. In that process, the fuel is burnt with a smoking flame in order to form seeds.

### SUMMARY OF THE INVENTION

The object of the present invention is to produce a carbon black that has a higher activity when used as a support material for electrocatalysts in fuel cells.

The invention provides a furnace carbon black, characterized in that it has a hydrogen (H) content of greater than 4000 ppm, determined by CHN analysis, and a peak integral ratio, determined by inelastic neutron scattering (INS), of non-conjugated H atoms (1250-2000 cm⁻¹) to aromatic and graphitic H atoms (1000-1250 cm⁻¹ and 750-1000 cm⁻¹) of less than 1.22.

The H content may be greater than 4200 ppm, preferably greater than 4400 ppm. The peak integral ratio of non-conjugated H atoms (1250-2000 cm⁻¹) to aromatic and graphitic H atoms (1000-1250 cm⁻¹ and 750-1000 cm⁻¹) may be less than 1.20.

The CTAB surface area may be from 20 to 200 m²/g, preferably from 20 to 70 m²/g. The DBP number may be from 40 to 160 ml/100 g, preferably from 100 to 140 ml/100 g.

The very high hydrogen content indicates a pronounced disturbance of the carbon lattice by an increased number of crystallite edges.

The invention further provides a process for the production of the furnace carbon black according to the invention in a carbon black reactor which contains, along the axis of the reactor, a combustion zone, a reaction zone and a termination zone, by producing a stream of hot waste gas in the combustion zone by completely burning a fuel in an oxygen-containing gas and passing the waste gas from the combustion zone through the reaction zone into the termination zone, mixing a carbon black raw material with the hot waste gas in the reaction zone and stopping the formation of carbon black in the termination zone by spraying in water. The process is characterized in that a liquid carbon black raw material and a gaseous carbon black raw material are injected at the same point.

The liquid carbon black raw material may be atomized by pressure, steam, compressed air or the gaseous carbon black raw material.

Liquid hydrocarbons burn more slowly than gaseous hydrocarbons since they must first be converted into the gaseous form, i.e., they must be vaporized. As a result, the carbon black contains components that are formed from the gas and components that are formed from the liquid.

The so-called K factor is frequently used as the measurement value for characterizing the excess of air. The K factor is the ratio of the amount of air required for stoichiometric combustion of the fuel to the amount of air actually supplied to the combustion. A K factor of 1, therefore, means stoichiometric combustion. Where there is an excess of air, the K factor is less than 1. K factors of from 0.3 to 0.9 may be applied, as in the case of known carbon blacks. K factors of from 0.6 to 0.7 are preferably used.

Liquid aliphatic or aromatic, saturated or unsaturated hydrocarbons or mixtures thereof, distillates from coal tar or residue oils which are formed in the catalytic cracking of crude oil fractions or in the production of olefins by cracking naphtha or gas oil, may be used as the liquid carbon black raw material.

Gaseous aliphatic, saturated or unsaturated hydrocarbons, mixtures thereof or natural gas may be used as the gaseous carbon black raw material.

The process described is not limited to a particular reactor geometry. Rather, it may be adapted to different types of reactor and sizes of reactor.

The carbon black raw material atomizers used may be both pure mechanical atomizers (single-component atomizers) and two-component atomizers with internal or external-mixing. It is possible for the gaseous carbon black raw material to be used as the atomizing medium. The above-described combination of a liquid and a gaseous carbon black raw material may therefore be implemented, for example, by using the gaseous carbon black raw material as the atomizing medium for the liquid carbon black raw material.

Two-component atomizers may preferably be used for atomizing the liquid carbon black raw material. While in the case of single-component atomizers, a change in the throughput may also lead to a change in the droplet size, the droplet size in the case of two-component atomizers can be influenced largely independently of the throughput.

Using the process according to the invention it is possible to produce the entire range of industrial furnace carbon blacks. The measures necessary therefor, such as, for example, the setting of the dwell time in the reaction zone and the addition of additives to influence the structure of the carbon black, are known to a person skilled in the art.

### BRIEF DESCRIPTION OF THE DRAWINGS

FIG. 1 illustrates, schematically, a carbon black reactor used in a process of the invention.

FIG. 2 illustrates, schematically, an axial lance having nozzleheads, used in a process of the invention.

### DETAILED DESCRIPTION OF THE PREFERRED EMBODIMENTS

### EXAMPLES

In the Examples and Comparative Examples that follow, furnace carbon blacks according to the invention are produced and their use as a support material for electrocatalysts is described. The electrochemical performance data in a fuel cell are used as the criterion for evaluating the furnace carbon blacks.

Production of Carbon Black B1:

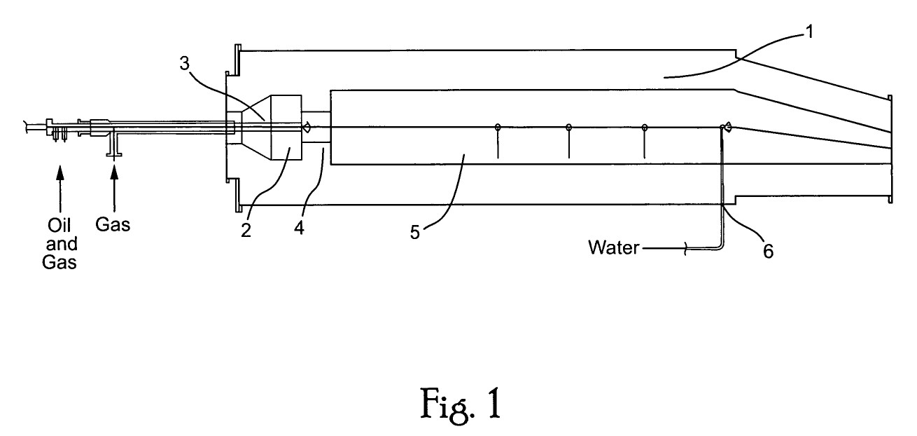

A carbon black according to the invention is produced in the carbon black reactor 1 shown in FIG. 1. The carbon black reactor 1 has a combustion chamber 2. The oil which is the liquid carbon black raw material and the gas which is the gaseous carbon black raw material are introduced into the combustion chamber through the axial lance 3. The lance may be displaced in the axial direction in order to optimize carbon black formation.

The combustion chamber leads to a narrow portion 4. After passing through the narrow portion, the reaction gas mixture expands into the reaction chamber 5.

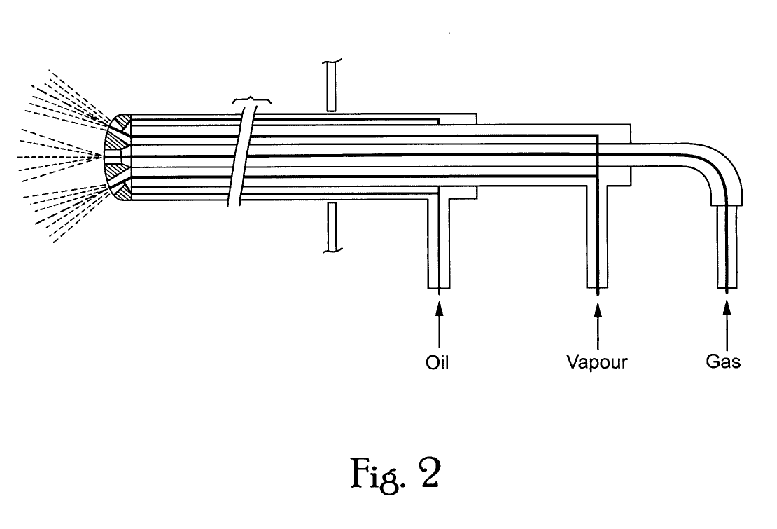

The lance has suitable spray nozzles at its head (FIG. 2).

The combustion zone, the reaction zone and the termination zone, which are important for the process according to the invention, cannot be separated sharply from one another. Their axial extent depends on the positioning of the lances and the quenching water lance 6 in each particular case.

The non-limiting dimensions of an exemplary reactor used are as indicated below:

| | |
|---|---|
| largest diameter of the combustion chamber: | 696 mm |
| length of the combustion chamber to the | 630 mm |
| narrow portion: | |
| diameter of the narrow portion: | 140 mm |
| length of the narrow portion: | 230 mm |
| diameter of the reaction chamber: | 802 mm |
| position of the oil lances¹⁾ | +160 mm |
| position of the quenching water lances¹⁾ | 2060 mm |

¹⁾measured from the zero point (beginning of the narrow portion)

The reactor parameters for the production of the carbon black according to the invention are listed in the table below.

Reactor parameters

Carbon black

| Parameter | Unit | B1 |
|---|---|---|
| Combustion air | Nm³/h | 1500 |
| Combustion air temperature | ° C. | 550 |
| Σ natural gas | Nm³/h | 156 |
| k factor (total) | | 0.70 |
| Carbon black oil, axial | kg/h | 670 |
| Carbon black oil position | mm | +16 |
| Atomizing vapor | kg/h | 100 |
| Additive (K₂CO₃ solution) | l/h × g/l | 5.0 × 3.0 |
| Additive position | | axial |
| Reactor outlet | ° C. | 749 |
| Quenching position | mm | 9/8810 |

Characterization of Carbon Black B1:

The hydrogen content of the carbon blacks is determined by CHN elemental analysis (LECO RH-404 analyzer with thermal conductivity detector). The method of inelastic neutron scattering (INS) is described in the literature (P. Albers, G. Prescher, K. Seibold, D. K. Ross and F. Fillaux, Inelastic Neutron Scattering Study Of Proton Dynamics In Carbon Blacks, Carbon 34 (1996) 903 and P. Albers, K. Seibold, G. Prescher, B. Freund, S. F. Parker, J. Tomkinson, D. K. Ross, F. Fillaux, Neutron Spectroscopic Investigations On Different Grades Of Modified Furnace Blacks And Gas Blacks, Carbon 37 (1999) 437).

The INS (or IINS—inelastic incoherent neutron scattering) method offers some quite unique advantages for the more intensive characterization of carbon blacks and activated carbons.

In addition to the proven elemental-analytical quantification of the H content, the INS method allows the in some cases very small hydrogen content in graphitized carbon blacks (about 100-250 ppm), carbon blacks (about 2000-4000 ppm in furnace carbon blacks) and in activated carbons (about 5000-12000 ppm in typical catalyst supports) to be broken down in greater detail in respect of its bond states.

The table below lists the values of the total hydrogen content of the carbon blacks, determined by CHN analysis (LECO RH-404 analyzer with thermal conductivity detector). In addition, the spectra integrals are given, which are determined as follows: integration of the regions of an INS spectrum of 750-1000 cm⁻¹ (A), 1000-1250 cm⁻¹ (B) and 1250-2000 cm⁻¹ (C). The aromatic and graphitic H atoms are formed by the sum of the peak integral A and B.

The carbon blacks are introduced without further pretreatment into specially developed aluminum (Al) cuvettes (Al having a purity of 99.5%, cuvette wall thickness 0.35 mm, cuvette diameter 2.5 cm). The cuvettes are hermetically sealed (flange gasket from Kalrez O-ring).

| | | Peak integral by | | | |
|---|---|---|---|---|---|
| | | INS measurements | | | Ratio |
| | | A | B | C | C/(A + B) |
| | | 750-1000 cm⁻¹ | 1000-1250 cm⁻¹ | 1250-2000 cm⁻¹ | non- |
| | H content | out of | in | C—H— | conjugated H |
| | [ppm] by | plane | plane | deformation | atoms to |
| | CHN | C—H— | C—H— | vibration of | aromatic and |
| Carbon | elemental | deformation | deformation | non-conjugated | graphitic H |
| black | analysis | vibration | vibration | constituents | atoms |
| B1 | 4580 ± 300 | 107 ± 1 | 99 ± 1 | 241 ± 3 | 1.17 |
| N 234 | 3853 | 23.2 ± 1 | 21.4 ± 1 | 55 ± 3 | 1.23 |
| EB 111 | 4189 | 27.4 ± 1 | 26.1 ± 1 | 68 ± 3 | 1.27 |
| (DE | | | | | |
| 19521565) | | | | | |
| Vulcan | 2030 ± 200 | 69 ± 1 | 63 ± 1 | 176 ± 3 | 1.33 |
| XC-72 | | | | | |
| Furnace | | | | | |
| carbon | | | | | |
| black | | | | | |

Accordingly, carbon black B1 exhibits quantitatively more hydrogen relative to the other carbon blacks, but its sp³/sp²-H ratio is lower, that is to say the additional amount of hydrogen is bonded especially aromatically/graphitically. There are C—H— protons at cleavage edges and defects saturated with hydrogen, and hence the surface is on average more greatly disturbed. Nevertheless, carbon black B1, when considered in absolute terms, at the same time also has the highest proportion of disturbed, non-conjugated constituents, without on the other hand—in relative terms—its sp³/sp² nature being drastically altered in the direction of sp³.

The surface area ratio of the specific surface areas BET adsorption by CTAB (cetylammonium bromide) adsorption is determined according to standard DIN 66 132.

| | CTAB | | BET:CTAB |
|---|---|---|---|
| | surface area | BET surface | surface area |
| Carbon black | [m²/g] | area [m²/g] | ratio |
| B1 | 30 | 30 | 1 |

### Example 1

20.1 g of carbon black B1 (0.5 wt. % moisture) are suspended in 2000 ml of demineralized water. After heating to 90° C. and adjustment of the pH value to 9 using sodium hydrogen carbonate, 5 g of platinum in the form of hexachloroplatinic acid solution (25 wt. % Pt) are added, and the suspension is adjusted to pH 9 again, reduced with 6.8 ml of formaldehyde solution (37 wt. %), washed, after filtration, with 2000 ml of demineralized water and dried in vacuo for 16 hours at 80° C. The resulting electro-catalyst has a platinum content of 20 wt. %.

### Comparative Example 1

Analogously to Example 1, 20.0 g of carbon black Vulcan XC-72 R (based on dry weight) from Cabot are suspended in 2000 ml of demineralized water. The electrocatalyst is prepared in the same manner as described in Example 1. After drying in vacuo, an electrocatalyst having a platinum content of 20 wt. % is obtained.

### Example 2

A solution of 52.7 g of hexachloroplatinic acid (25 wt. % Pt) and 48.4 g of ruthenium(III) chloride solution (14 wt. % Ru) in 200 ml of deionized water is added, with stirring, at room temperature, to a suspension of 80.4 g of carbon black B1 (0.5 wt. % moisture) in 2000 ml of demineralized water. The mixture is heated to 80° C. and the pH value is adjusted to 8.5 using sodium hydroxide solution. After the addition of 27.2 ml of a formaldehyde solution (37 wt. %), the mixture is filtered off and washed with 2000 ml of demineralized water, and the moist filter cake is dried at 80° C. in a vacuum drying cabinet. An electrocatalyst containing 13.2 wt. % platinum and 6.8 wt. % ruthenium is obtained.

### Comparative Example 2

Analogously to Example 2, using 81.1 g of carbon black Vulcan XC-72 R (1.39 wt. % moisture) as catalyst support, a platinum/ruthenium catalyst containing 13.2 wt. % Pt and 6.8 wt. % Ru is obtained.

The synthesis of Comparative Example 2 is described in DE 197 21 437, in Example 1.

For the purpose of electrochemical characterization, the electrocatalysts are processed to form a membrane electrode assembly (MEA). The electrocatalyst according to the invention of Example 1 and the electrocatalyst of Comparative Example 1 are characterized as cathode catalysts in hydrogen/air and hydrogen/oxygen operation. The electrocatalyst according to the invention of Example 2 and the electrocatalyst of Comparative Example 2 are tested as CO-tolerant anode catalysts in reformate/oxygen operation.

The cathode and anode catalysts are applied to an ion-conductive membrane (Nafion 115) according to Example 1 of the process described in U.S. Pat. No. 5,861,222. The membrane so coated is placed between two carbon papers (TORAY, TCG 90) which have been rendered hydrophobic in a conductive manner. The coating on the cathode and anode sides is in each case 0.25 mg of platinum/cm². The resulting membrane electrode assembly (MEA) is measured in a PEM single cell (pressureless operation, temperature 80° C.), a current density of 0.4 A/cm² being set.

For the electrochemical testing of the cathode catalysts, both sides of the membrane are coated with a paste of a platinum catalyst described in Example 1 or Comparative Example 1.

Oxygen or air is used as the fuel gas on the cathode, and hydrogen is used on the anode.

| | |
|---|---|
| Cell | Cell |
| performance | performance |
| at 400 | at 500 |
| mA/cm² [mV] | mA/cm² [mV] |

| Catalyst | O₂ | air | O₂ | air |
|---|---|---|---|---|
| Example 1 | 687 | 606 | 649 | 545 |
| Comparative | 630 | 518 | 576 | 429 |
| Example 1 | | | | |

The preparation of a membrane electrode assembly for testing the anode catalyst is carried out completely analogously to the process according to U.S. Pat. No. 5,861,222 described for the cathode catalysts.

In that case, a supported Pt/Ru catalyst prepared according to Example 2 or Comparative Example 2 is used as the anode catalyst. On the cathode side, a platinum catalyst prepared according to Comparative Example 1 is used in both membrane electrode assemblies.

Measurement is carried out in a PEM single cell (operation with pressure at 3 bar, temperature 75° C.), a current density of 0.5 A/cm² being set.

The cell voltage U in hydrogen/oxygen operation (without the metering in of reformate and/or CO on the anode side) is used as a measure of the catalyst activity.

The voltage drop ΔU, which occurs after the metering in of 100 ppm of CO to the fuel gas, is used as a measure of the CO tolerance of the catalyst.

The following fuel gas composition in reformate/CO operation is used: 58 vol. % H₂; 15 vol. % N₂, 24 vol. % CO₂, 3 vol. % air (“airbleed”).

| | H₂/O₂ operation: | Reformate/O₂ | ΔU |
|---|---|---|---|
| | cell performance | operation: cell | CO-induced |
| | at 500 mA/cm² | performance at | voltage drop |
| Catalyst | [mV] | 500 mA/cm² [mV] | [mV] |
| Example 2 | 715 | 661 | −54 |
| Comparative | 686 | 620 | −66 |
| Example 2 | | | |

The cell performance is markedly increased for Examples 1 and 2 as compared with the respective comparative examples.

1. A supported electrocatalyst comprising at least one platinum group metal supported by a carbon black support, wherein the carbon black support is furnace carbon black having a hydrogen content of greater than 4200 ppm, determined by CHN analysis, and a peak integral ratio, determined by inelastic neutron scattering, of non-conjugated hydrogen atoms (1250 cm⁻¹-2000 cm⁻¹) to aromatic and graphitic hydrogen atoms (1000 cm⁻¹-1250 cm⁻¹ and 750 cm⁻¹-1000 cm⁻¹) of less than 1.22.

2. The supported electrocatalyst according to claim 1, wherein the peak interval ratio is less than 1.20.

3. The supported electrocatalyst according to claim 1, wherein furnace carbon black has a CTAB surface area from 20 to 200 m²/g.

4. The supported electrocatalyst according to claim 1, wherein furnace carbon black has a CTAB surface area from 20 to 70 m²/g.

5. The supported electrocatalyst according to claim 1, wherein furnace carbon black has a DBM number from 40 to 160 ml/100 g.

6. The supported electrocatalyst according to claim 1, wherein furnace carbon black has a DBM number from 100 to 140 ml/100 g.

7. The supported electrocatalyst according to claim 1, wherein the platinum group metal comprises Pt.

8. The supported electrocatalyst according to claim 1, wherein the platninum group metal comprises Ru.

9. The supported electrocatalyst according to claim 1, wherein the platinum group metal comprises a mixture of Pt and Ru.

10. A membrane electrode assembly comprising an ion conductive membrane coated with the electrocatalyst of claim 1.

11. A membrane electrode assembly comprising an ion conductive membrane coated with the electrocatalyst of claim 3.

12. A membrane electrode assembly comprising an ion conductive membrane coated with the electrocatalyst of claim 5.

13. A membrane electrode assembly comprising an ion conductive membrane coated with the electrocatalyst of claim 8.

14. A membrane electrode assembly comprising an ion conductive membrane coated with the electrocatalyst of claim 8.

15. A membrane electrode assembly comprising an ion conductive membrane coated with the electrocatalyst of claim 9.

16. A fuel cell comprising the membrane electrode assembly according to claim 10.

17. A fuel cell comprising the membrane electrode assembly according to claim 13.

18. A fuel cell comprising the membrane electrode assembly according to claim 14.

19. A fuel cell comprising the membrane electrode assembly according to claim 15.
